(19) United States
(12) Patent Application Publication
(10) Pub. No.: US 2020/0307320 A1
(43) Pub. Date: Oct. 1, 2020

(54) PNEUMATIC TIRE

(71) Applicant: Toyo Tire Corporation, Itami-shi (JP)

(72) Inventor: Tsuyoshi Fujioka, Itami-shi (JP)

(73) Assignee: Toyo Tire Corporation, Itami-shi (JP)

(21) Appl. No.: 16/801,453

(22) Filed: Feb. 26, 2020

(30) Foreign Application Priority Data
Mar. 26, 2019 (JP) 2019-057920

(51) Int. Cl. B60C 11/03; B60C 11/04; B60C 11/12

(52) U.S. Cl. CPC B60C 11/0306; B60C 11/12; B60C 11/047

(57) ABSTRACT

A tire has a first rib, a second rib and a third rib. The second rib and the third rib are adjacent to the first rib. The first rib has a first closed sipe that terminates within the first rib. The second rib has a second closed sipe that terminates within the second rib. The third rib has a third closed sipe that terminates within the third rib. The second closed sipe and the third closed sipe are inclined in mutually similar fashion with respect to the tire width direction. The first closed sipe is inclined in opposite fashion with respect to the tire width direction as the second closed sipe and the third closed sipe are inclined with respect to the tire width direction.

### BACKGROUND OF THE INVENTION

The present disclosure relates to a pneumatic tire.

Included among pneumatic tires are those which are intended for heavy loads such as may be used for trucks and the like, among which are rib tires, which are used in North America. In North America, there are what are referred to as “Long” rib tires for long-distance driving, for which performance with respect to resistance to uneven wear is desired; and there are what are referred to as “Regional” rib tires for short-distance driving in downtown areas and so forth, for which performance with respect to traction is desired. It is often the case that front-wheel tires which are mounted on front wheels employ a rib pattern, and there are many circumstances in which rear-wheel tires that are mounted on rear-wheel drive axles include a block pattern.

Reference is made of the fact that Japanese Patent No. 4705684 and Japanese Patent No. 5149955 make mention of wet performance and performance with respect to resistance to uneven wear in the context of tires intended for heavy loads.

### SUMMARY OF THE INVENTION

A first object of the present disclosure is the desire for improvement in performance with respect to resistance to uneven wear when used as a front-wheel tire.

A second object of the present disclosure is to provide a tire intended for heavy loads such as may be considered to be in a new category having both Long and Regional performance characteristics, such as will permit attainment of performance with respect to traction when used as a rear-wheel tire mounted on a drive axle, while at the same time permitting improvement in performance with respect to resistance to uneven wear when used as a front-wheel tire.

It is an object of the present disclosure to provide a pneumatic tire that will at least permit improvement in performance with respect to resistance to uneven wear when used as a front-wheel tire, which is the first object.

According of the present disclosure, there is provided a pneumatic tire having a first rib that is partitioned by a first pair of major gooves and that extends in a tire circumferential direction in parallel fashion with respect to a tire equator;

a second rib that is partitioned by a second pair of major grooves, that extends in the tire circumferential direction, and that is adjacent, to a first side in a tire width direction, to the first rib; and

a third rib that is partitioned by a third pair of major grooves, that extends in the tire circumferential direction, and that is adjacent, to a second side in the tire width direction, to the first rib;

wherein the first rib has, at a central portion in the tire width direction of the first rib, at least one first closed sipe that terminates within the first rib, the at least one first closed sipe being inclined with respect to the tire width direction and the tire circumferential direction, length of the at least one first closed sipe in the tire circumferential direction being greater than length of the at least one first closed sipe in the tire width direction;

wherein the second rib has, at a central portion in the tire width direction of the second rib, at least one second closed sipe that terminates within the second rib, the at least one second closed sipe being inclined with respect to the tire width direction and the tire circumferential direction, length of the at least one second closed sipe in the tire circumferential direction being greater than length of the at least one second closed sipe in the tire width direction;

wherein the third rib has, at a central portion in the tire width direction of the third rib, at least one third closed sipe that terminates within the third rib, the at least one third closed sipe being inclined with respect to the tire width direction and the tire circumferential direction, length of the at least one third closed sipe in the tire circumferential direction being greater than length of the at least one third closed sipe in the tire width direction;

wherein the at least one second closed sipe and the at least one third closed sipe are inclined in mutually similar fashion with respect to the tire width direction; and

wherein the at least one first closed sipe is inclined in opposite fashion with respect to the tire width direction as the at least one second closed sipe and the at least one third closed sipe are inclined with respect to the tire width direction.

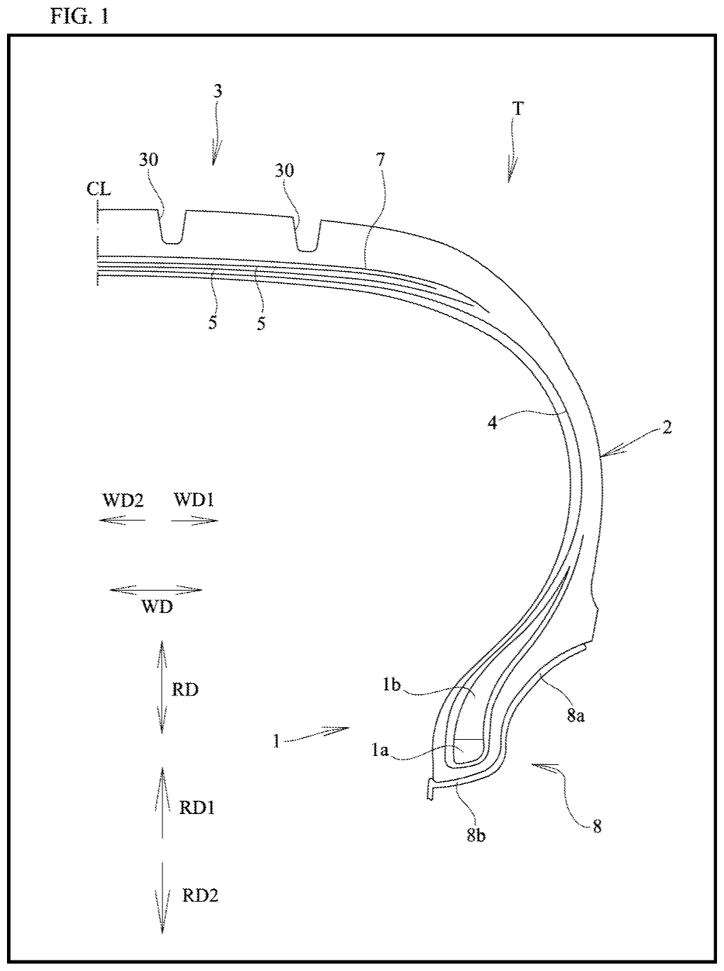

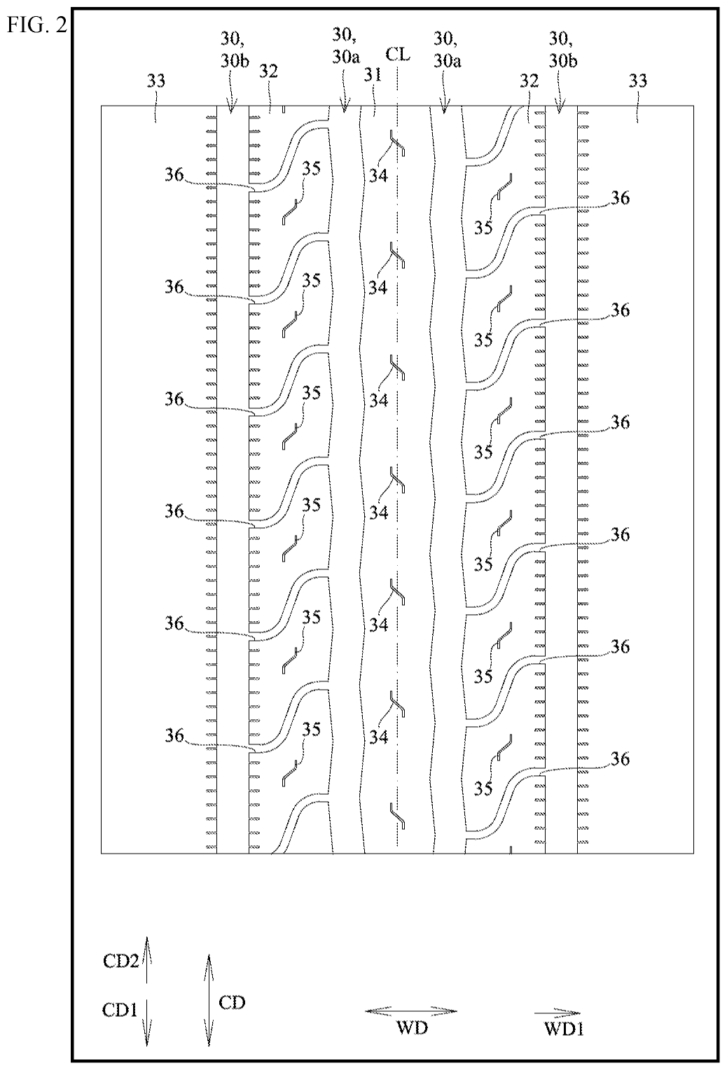

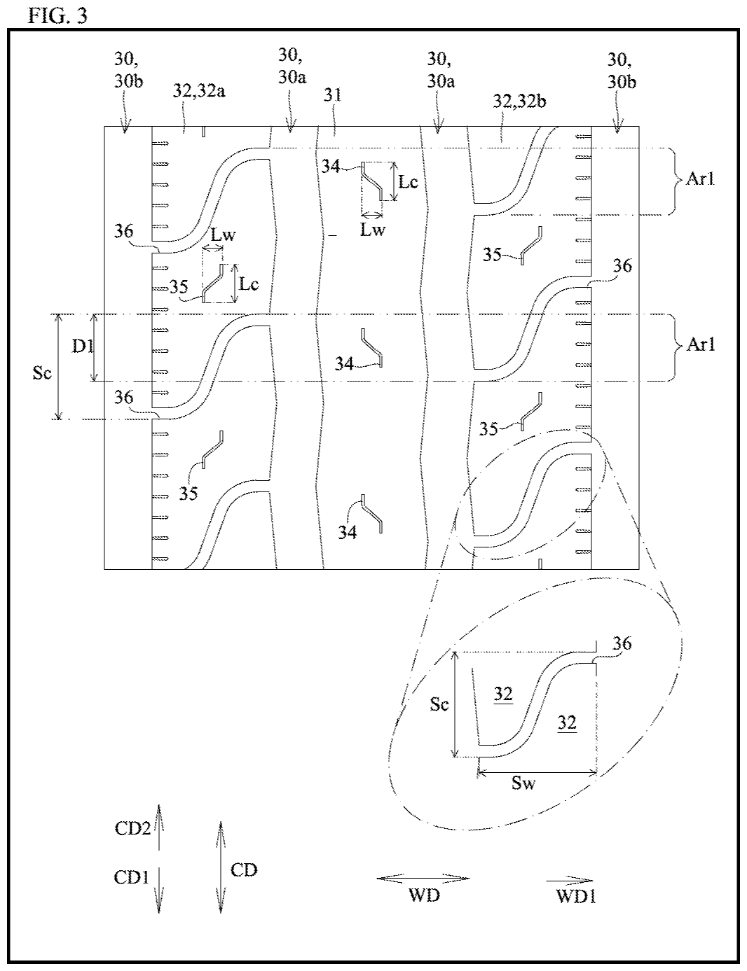

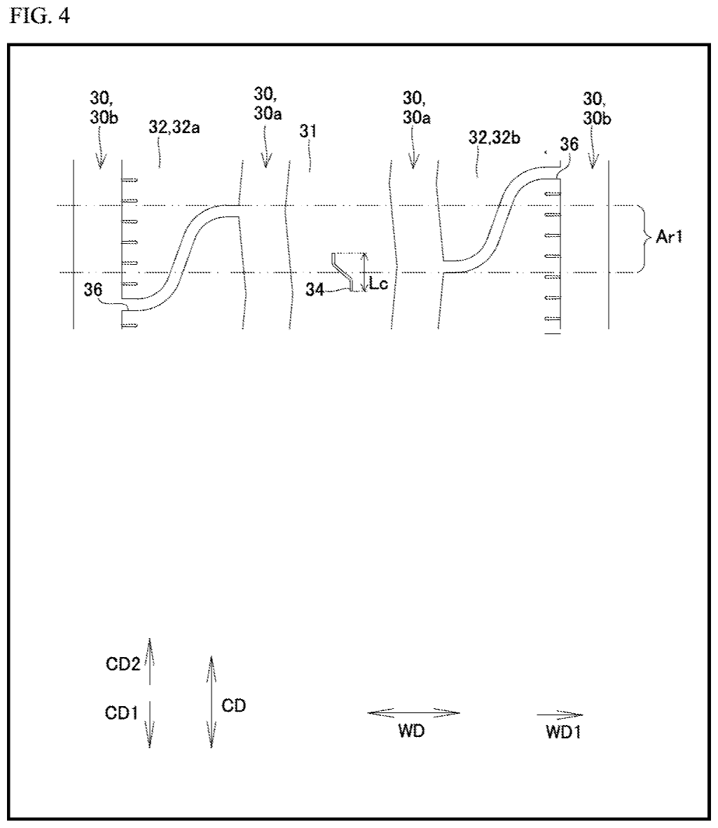

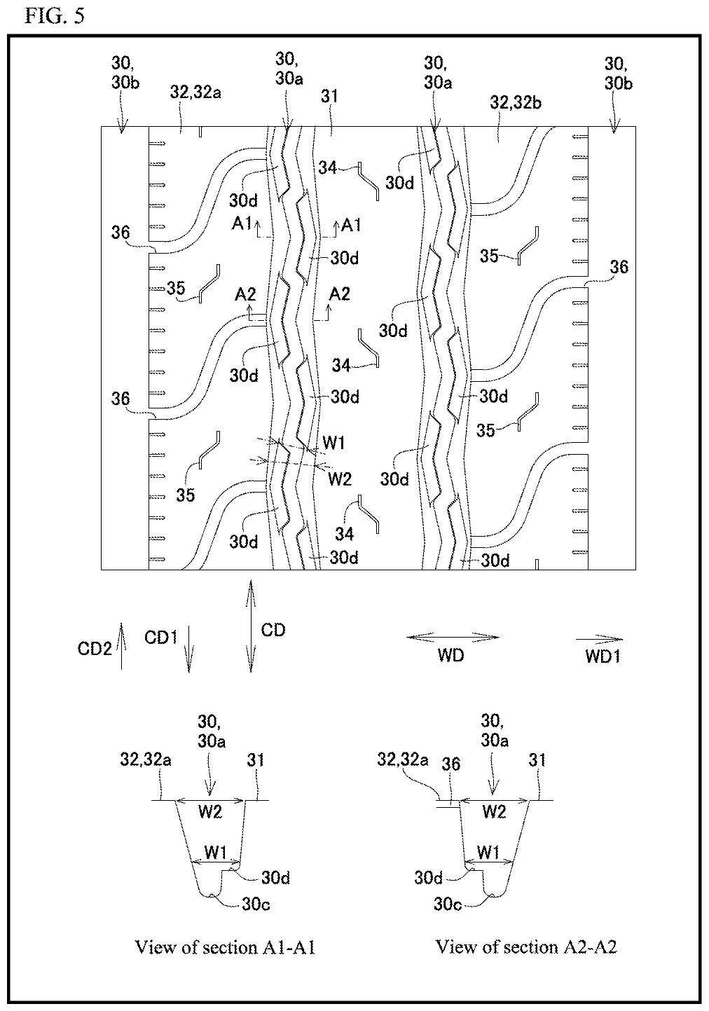

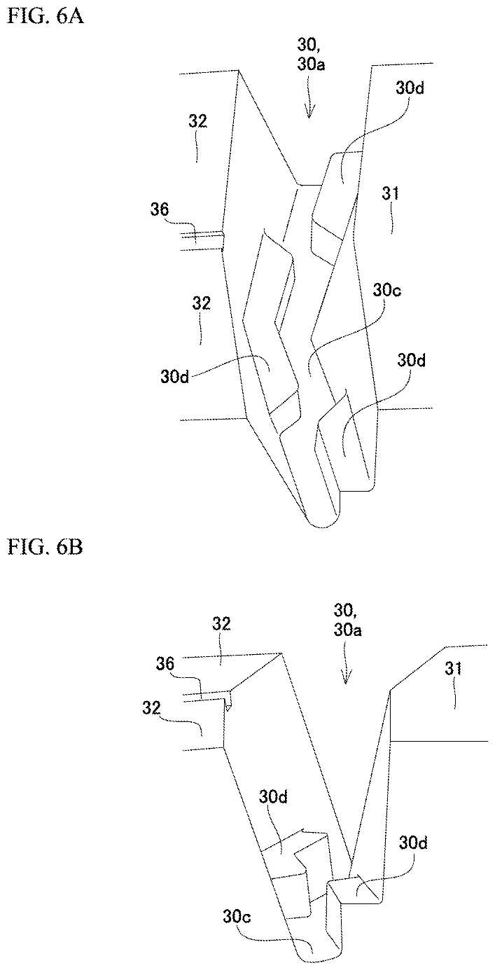

### BRIEF DESCRIPTION OF THE DRAWINGS

[FIG. 1] Drawing of tire meridional half-section showing an example of a pneumatic tire associated with the present embodiment

[FIG. 2] Plan view showing tread pattern in accordance with the present embodiment

[FIG. 3] Enlarged plan view showing center rib and mediate ribs

[FIG. 4] Enlarged plan view of tread pattern showing a variation

[FIG. 5] Plan view and sectional views showing shape of major moves that partition center rib

[FIG. 6A] Perspective view showing shape of major goove that partitions center rib

[FIG. 6B] Perspective view showing shape of major groove that partitions center rib

### DETAILED DESCRIPTION OF THE PREFERRED EMBODIMENTS

Below, a pneumatic tire in an embodiment in accordance with the present disclosure is described with reference to the drawings. In the drawings, “CD” refers to the tire circumferential direction, “WD” refers to the tire width direction, and “RD” refers to the tire radial direction. The respective drawings show shapes as they would exist when the tire is still new.

As shown in FIG. 1, pneumatic tire T is provided with a pair of bead 1; sidewall 2 which extend toward the exterior RD1 in the tire radial direction from the respective bead 1; and tread 3 which mutually connects the ends toward the exterior RDI in the tire radial direction of the sidewall 2. Arranged at bead 1 are annular bead core 1a at which steel wire or other such convergent body is coated with rubber, and bead filler 1b which comprises hard rubber. Bead 1 is mounted on bead sheet 8b of rim 8, and—provided that the air pressure is as it should be (e.g., air pressure as determined by JATMA)—is fitted in appropriate fashion to rim flange 8a by virtue of the tire internal pressure, such that the tire is made to engage with rim 8.

Furthermore, this tire is provided with toroidal carcass layer 4 which is arranged so as to span the distance between the pair of bead 1 and which extends from tread 3 and passes through sidewall 2 to reach bead 1. Carcass layer 4 is made up of at least one carcass ply, and has end regions that are routed by way of bead cores 1a to be retained in upturned fashion. Arranged toward the inside circumferential surface of carcass layer 4 is inner liner rubber (not shown) for retention of air pressure.

Arranged at the outside circumferential surface of carcass layer 4 at tread 3 is belt layer 5 which reinforces carcass layer 4 by virtue of the barrel hoop effect. Belt layer 5 has two belt plies that have cords which extend so as to be inclined by prescribed angle(s) with respect to the tire circumferential direction, the respective plies being laminated together in such fashion that the cords thereof intersect in mutually oppositely inclined fashion. Arranged toward the outside circumferential surface of belt layer 5 is belt reinforcing layer 7, and arranged at the outside circumferential surface further in that direction therefrom is the tread rubber at which the tread pattern is formed.

As examples of rubber raw material for the aforementioned rubber layers and so forth, natural rubber, styrene-butadiene rubber (SBR), butadiene rubber (BR), isoprene rubber (IR), butyl rubber (IIR), and so forth may be cited, it being possible for any one of these to be used alone, or for any two or more of these to be used in combination. Furthermore, such rubber(s) may be reinforced with carbon black, silica, and/or other such filler, and vulcanizing agent, vulcanization accelerator, plasticizer, antioxidant, and/or the like may be blended thereinto as appropriate.

FIG. 2 is a plan view showing the tread pattern at a tire in accordance with the present embodiment. As shown in FIG. 2, at the tread of a tire in accordance with the present embodiment, a plurality of major grooves 30 (30a, 30b) are formed. The tread has center rib 31 which extends in the tire circumferential direction CD in parallel fashion with respect to the tire equator CL, and a pair of mediate ribs 32 which extend in the tire circumferential direction CD and which are adjacent, to either side in the tire width direction WD, to center rib 31. Center rib 31 is partitioned by two major grooves 30a. Mediate rib 32 is partitioned by two major grooves 30a, 30b. Moreover, the major grooves 30b that are outwardmost in the tire width direction WD partition shoulder ribs 33.

As shown in FIG. 2, the center rib 31 and the pair of mediate ribs 32 have a plurality of closed sipes 34, 35 at central portions in the tire width direction WD of the respective ribs 31, 32. The plurality of closed sipes 34, 35 terminate within the ribs, and are arranged at spaced intervals in the tire circumferential direction CD. As shown in FIG. 3, the respective closed sipes 34, 35 are inclined with respect to the tire width direction WD and the tire circumferential direction CD as seen in plan view, length Lc in the tire circumferential direction CD being greater than length Lw in the tire width direction WD. Thus, because closed sipes 34, 35 are such that length Lc in the tire circumferential direction CD is greater than length Lw in the tire width direction WD, it is possible to suppress lateral sliding that might otherwise occur when a lateral force directed in the tire width direction WD is applied thereto during turns. To suppress lateral sliding and better suppress occurrence of uneven wear, it is preferred that, as seen in plan view, the length Lc in the tire circumferential direction CD of the respective closed sipes 34, 35 be not less than 1.5 times the length Lw thereof in the tire width direction WD.

As shown in FIG. 2 and FIG. 3, the plurality of closed sipes 34 arranged at center rib 31, and the plurality of closed sipes 35 arranged at the pair of mediate ribs 32, are inclined in mutually opposite fashion with respect to the tire width direction WD. By way of example, closed sipes 34 at center rib 31 are inclined so as to be directed downward as one proceeds to the right. Stating this another way, closed sipes 34 at center rib 31 extend so as to be directed toward first direction WD1 in the tire width direction and first direction. CD1 in the tire circumferential direction. Closed sipes 35 at mediate ribs 32 are inclined so as to be directed upward as one proceeds to the right. Stating this another way, closed sipes 35 at mediate ribs 32 extend so as to be directed toward first direction WD1 in the tire width direction and second direction CD2 in the tire circumferential direction. Thus, because closed sipes 34, 35 are inclined in mutually opposite directions with respect to the tire width direction WD depending on whether they are in center rib 31 or in mediate ribs 32, it is possible to suppress sliding that might otherwise occur when lateral forces of various inclinations are applied thereto during turns, and it is possible to suppress occurrence of uneven wear.

Closed sipes 34, 35 are such that the depths thereof are less than the depths of the major grooves, and are such that the widths thereof are less than the widths of the major grooves. Whereas in the present embodiment the width of closed sipes 34, 35 is 0.6 mm, there is no limitation with respect thereto. It is preferred that the widths of closed sipes 34, 35 be not less than 0.3 mm but not greater than 1.5 mm. Whereas in the present embodiment the depths of closed sipes 34, 35 are less than the depths of the major grooves, being 11.6 mm, which is 70% of the depth of major rooves 30, there is no limitation with respect thereto. It is preferred that the depths of dosed sipes 34, 35 be not less than 30% but not greater than 80% of the depths of major grooves 30.

As shown in FIG. 2 and FIG. 3, mediate rib 32 has a plurality of slits 36 that extend in the tire circumferential direction and in the tire width direction, and that open into two major grooves 30a, 30b which partition mediate rib 32. The plurality of slits 35 are arranged at spaced intervals in the tire circumferential direction CD. The slits 36 are arranged between closed sipes 35. Because slits 36 extend in the tire width direction WD and open into major grooves 30a, 30b, achievement of traction is made possible. It will therefore be possible for the tire to be mounted and used as a rear-wheel tire. Moreover, because slits 36 extend in the tire circumferential direction CD, it is possible to suppress lateral sliding, and it is possible to suppress occurrence of uneven wear. Slits 36 are such that the widths thereof are less than the widths of major rooves 30, and are such that the depths thereof are less than the depths of major grooves 30. Whereas in the present embodiment the width of slits 36 is 3.0 mm, which is approximately 25% of the width of the major grooves, there is no limitation with respect thereto. Whereas in the present embodiment the depth of slits 36 is 1.0 mm, there is no limitation with respect thereto. Moreover, the widths of slits 36 are greater than the widths of closed sipes 34, 35.

As shown in FIG. 3, it is preferred that length Sc in the tire circumferential direction CD of slits 36 be not less than 0.8 times but not greater than 1.2 times length Sw in the tire width direction WD. As a result of adoption of such constitution, because length Sw in the tire width direction WD and length Sc in the tire circumferential direction CD of slits 36 will have been chosen so as to be more or less the same, this will make it possible for performance with respect to traction and performance with respect to resistance to lateral sliding to be achieved in well-balanced fashion. Moreover, because contact patch pressure is high at center rib 31, making it less likely to slide, elements for causing reduction in rib rigidity (i.e., slits 36) are not provided thereat.

As shown in FIG. 3, one of the pair of mediate ribs 32 is referred to as first mediate rib 32a, while the other is referred to as second mediate rib 32b. As shown in same drawing, the positional relationship between slits 36 at first mediate rib 32a and slits 36 at second mediate rib 32b is such that they mutually overlap as seen when projected onto the equatorial plane CL, such that regions Ar1 within which two slits overlap occur in repeated fashion at spaced intervals in the tire circumferential direction CD. Whereas in the present embodiment all portions of the respective closed sipes 34 at center rib 31 lie within the foregoing overlapping regions Ar1, there is no limitation with respect thereto. For example, as shown in FIG. 4, it is sufficient that at least a portion of each of the respective closed sipes 34 at center rib 31 lies within an overlapping region Ar1. To appropriately suppress lateral sliding, it is preferred that closed sipes 34 at center rib 31 be such that not less than 50% of the lengths Lc thereof in the tire circumferential direction CD lie within the foregoing overlapping regions Ar1.

As shown in FIG. 3, it is preferred that dimension D1 in the tire circumferential direction of region Ar1 of overlap of slits 36 be not less than 40% but not greater than 80% of length Sc in the tire circumferential direction CD of slits 36 at first mediate rib 32a and second mediate rib 32b. This is because if this were to be below 40%. the overlapping region would be too small, reducing the effect whereby lateral sliding is suppressed. And if this were to be above 80%, this would increase the size of the regions along the tire circumference that do not lie within regions Ar1, where slits 36 are not arranged, which would contribute to occurrence of uneven wear. In accordance with the present embodiment, dimension D1 in the tire circumferential direction of region Ar1 of overlap of slits 36 is approximately 64% of length Sc in the tire circumfrential direction CD of slits 36 at first mediate rib 32a and second mediate rib 32b.

FIG. 5 is a plan view and sectional views of major grooves 30a that partition center rib 31. FIG. 6A and FIG. 6B are perspective views showing portion A1-A1 in FIG. 5. As shown in same drawing, major grooves 30a extend in zigzag fashion in the tire circumferential direction. CD, groove width W1 at the base thereof being less than groove width W2 at the opening thereof. Furthermore, major grooves 30a are such that amplitude at the base thereof is greater than amplitude at the opening thereof. At a curved outer portion of the groove base, major groove 30a has a shelf portion 30d which protrudes from the groove base 30c. Slit 36 opens into the curved outer portion at which shelf portion 30d is provided.

As described above, a pneumatic tire in accordance with the present embodiment having a first rib 31 that is partitioned by a first pair of major grooves (30a, 30a) and that extends in a tire circumferential direction CD in parallel fashion with respect to a tire equator CL; a second rib 32a that is partitioned by a second pair of major grooves (30a, 30b), that extends in the tire circumferential direction CD, and that is adjacent, to a first side in a tire width direction WD, to the first rib 31; and a third rib 32b that is partitioned by a third pair of major grooves (30a, 30b), that extends in the tire circumferential direction CD, and that is adjacent, to a second side in the tire width direction WD, to the first rib 31; wherein the first rib 31 has, at a central portion in the tire width direction WD of the first rib 31, at least one first closed sipe 34 that terminates within the first rib 31, the at least one first closed sipe 34 being inclined with respect to the tire width direction WD and the tire circumferential direction CD, length Lc of the at least one first closed sipe 34 in the tire circumferential direction CD being greater than length Lw of the at least one first closed sipe 34 in the tire width direction WD; wherein the second rib 32a has, at a central portion in the tire width direction WD of the second rib 32a, at least one second closed sipe 35 that terminates within the second rib 32a, the at least one second closed sipe 35 being inclined with respect to the tire width direction WD and the tire circumferential direction CD, length Lc of the at least one second closed sipe 35 in the tire circumferential direction CD being greater than length Lw of the at least one second closed sipe 35 in the tire width, direction WD; wherein the third rib 32b has, at a central portion in the tire width direction WD of the third rib 32b, at least one third closed sipe 35 that terminates within the third rib 32b, the at least one third dosed sipe 35 being inclined with respect to the tire width direction WD and the tire circumferential direction CD, length Lc of the at least one third closed sipe 35 in the tire circumferential direction CD being greater than length Lw of the at least one third closed sipe 35 in the tire width direction WD; wherein the at least one second closed sipe 35 and the at least one third closed sipe 35 are inclined in mutually similar fashion with respect to the tire width direction WD; and wherein the at least one first closed sipe 34 is inclined in opposite fashion with respect to the tire width direction WD as the at least one second closed sipe 35 and the at least one third closed sipe 35 are inclined with respect to the tire width direction WD.

Thus, because closed sipes 34, 35 are arranged at central portions in the tire width direction of center rib 31 and mediate ribs 32, it is possible for closed sipes 34, 35 to relieve contact patch pressure at the central portions in the tire width direction where contact patch pressure might otherwise become too high were it not for presence of closed sipes 34, 35, and it is possible to achieve increased uniformity in contact patch pressure, and to suppress uneven wear. Moreover, because closed sipes 34, 35 are inclined with respect to the tire width direction WD and the tire circumferential direction CD as seen in plan view, and because length Lc in the tire circumferential direction CD is greater than length Lw in the tire width direction WD, it is possible to suppress lateral sliding that might otherwise occur when a lateral force directed in the tire width direction WD is applied thereto. At the same time, because closed sipes 34, 35 are inclined in mutually opposite directions with respect to the tire width direction WD depending on whether they are in center rib 31 or in mediate ribs 32, it is possible to suppress sliding that might otherwise occur when lateral forces of various inclinations are applied thereto during turns, and it is possible to suppress occurrence of uneven wear.

As is the case in the present embodiment, it is preferred that the length Lc in the tire circumferential direction CD of the at least one first closed sipe 34 is not less than 1.5 times the length Lw in the tire width direction WD of the at least one first closed sipe 34; the length Lc in the tire circumferential direction CD of the at least one second closed sipe 35 is not less than 1.5 times the length Lw in the tire width direction WD of the at least one second closed sipe 35 and the length Lc in the tire circumferential direction CD of the at least one third closed sipe 35 is not less than 1.5 times the length Lw in the tire width direction WD of the at least. one third closed sipe 35.

When this is mounted and used as a fiont-wheel tire, there is a tendency to for it to be affected by lateral forces during turns. Thus, because length Lc in the tire circumferential direction CD of closed sires 34, 35 is not less than 1.5 times the length Lw thereof in the tire width direction WD, it is possible to better suppress lateral sliding, and it is possible to suppress occurrence of uneven wear.

As is the case in the present embodiment, it is preferred that the second rib 32a has at least one pair of second slits 36 that extend in the tire circumferential direction CD and that open into the second pair of major grooves (30a, 30b), the at least one second closed sipe 35 being arranged in interposed fashion between the at least one pair of second slits 36; and wherein the third rib 32b has at least one pair of third slits 36 that extend in the tire circumferential direction CD and that open into the third pair of major grooves (30a, 30b), the at least one third closed sipe 35 being arranged in interposed fashion between the at least one pair of third slits 36.

Thus, because slits 36 extend in the tire width direction WD and open into major grooves 30a, 30b, it is possible to achieve traction, and it will be possible for the tire to be mounted and used as a rear-wheel tire. Moreover, because slits 36 extend in the tire circumferential direction CD, it is possible to suppress lateral sliding, and it is possible to suppress occurrence of uneven wear.

As is the case in the present embodiment, it is preferred that length Sc in the tire circumferential direction CD of each of the second slits 36 is not less than 0.8 but not greater than 1.2 times length Sw in the tire width direction WD of each of the second slits 36; and wherein length Sc in the tire circumferential direction CD of each of the third slits 36 is not less than 0.8 but not greater than 1.2 times length Sw in the tire width direction WD of each of the third slits 36.

As a result of adoption of such constitution, because length Sw in the tire width direction WD and length Sc in the tire circumferential direction CD of slits 36 will have been chosen so as to be more or less the same, this will make it possible for performance with respect to traction and performance with respect to resistance to lateral sliding to be achieved in well-balanced fashion.

As is the case in the present embodiment, it is prefiHred that as seen when projected onto an equatorial plane CL, at least one of the second slits 36 and at least one of the third slits 36 at least partially mutually overlap to create at least one overlapping region Ar1; and wherein, as seen when projected onto the equatorial plane CL, at least a portion of the at least one first closed sipe 34 lies within the at least one overlapping region Ar1.

Thus, because at least a portion of closed sipes 34 of center rib 31 lie within regions Ar1 at which slits 36 of first mediate rib 32a and second mediate rib 32b mutually overlap as seen when projected onto the equatorial plane CL, it will be the case that sipe 34 and two slits 36 which suppress lateral sliding will lie within overlapping region Ar1, as a result of which it will be possible to better suppress lateral sliding, and it will be possible to suppress occurrence of uneven wear.

As is the case in the present embodiment, it is preferred that as seen when projected onto the equatorial plane CL, the at least one first closed sipe 34 lies entirely within the at least one overlapping region Ar1.

As a result of adoption of such constitution, it will be passible to suppress lateral sliding and to suppress occurrence of uneven wear.

As is the case in the present embodiment, it is preferred that as seen when projected onto the equatorial plane CL, length D1 in the tire circumferential direction CD of the at least one overlapping region Ar1 is not less than 40% but not greater than 80% of length Sc in the tire circumferential direction CD of the at least one second slit 36 and of the at least one third slit 36 that appear to mutually overlap as seen when projected onto the equatorial plane CL.

This is because if length D1 in the tire circumferential direction of overlapping region Ar1 were to be less than 40% of length Se in the tire circumferential direction CD of slits 36 at respective mediate ribs 32, overlapping region Ar1 would be too small, and there would be little effect whereby lateral sliding is suppressed. And if the foregoing value were to be greater than 80%, this would increase the size of the portion at which slits 36 are not arranged along the tire circumference, which would contribute to occurrence of uneven wear. Accordingly, within the foregoing numerical range, attainment of effect with respect to lateral sliding and suppression of occurrence of uneven wear will be possible.

As is the case in the present embodiment, it is preferred that the first pair of major grooves (30a, 30a) respectively extend in zigzag fashion in the tire circumferential direction CD such that at least one groove wall of the first pair of major grooves (30a, 30a) has at least one convex groove wall portion and at least one concave groove wall portion; wherein each of the first pair of major (30a, 30a) grooves has a greater groove width at a base thereof than at an opening thereof; and wherein at least one shelf portion 30d protrudes from the groove base 30c at the at least one concave groove wall portion.

Thus, because major groove 30a is such that the amplitude at the base thereof is greater than the amplitude at the opening thereof, it will be possible to attain performance with respect to traction during the middle and final stages of wear. Moreover, because at a curved outer portion of a groove base there is a shelf portion 30d that protrudes from the groove base 30c, not only will it be possible to suppress occurrence of the situation whereby pebbles become lodged in the tread, but it will also be possible to improve performance with respect to traction as a result of presence of the shelf portion.

While embodiments in accordance with the present disclosure have been described above with reference to the drawings. it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
a first rib that is partitioned by a first pair of major grooves and that extends in a tire circumferential direction in parallel fashion with respect to a tire equator;
a second rib that is partitioned by a second pair of major grooves, that extends in the tire circumferential direction, and that is adjacent, to a first side in a tire width direction, to the first rib; and
a third rib that is partitioned by a third pair of major grooves, that extends in the tire circumferential direction, and that is adjacent, to a second side in the tire width direction, to the first rib;
wherein the first rib has, at a central portion in the tire width direction of the first rib, at least one first closed sipe that terminates within the first rib, the at least one first closed sipe being inclined with respect to the tire width direction and the tire circumferential direction, length of the at least one first closed sipe in the tire circumferential direction being greater than length of the at least one first closed sipe in the tire width direction;
wherein the second rib has, at a central portion in the tire width direction of the second rib, at least one second closed sipe that terminates within the second rib, the at least one second closed sipe being inclined with respect to the tire width direction and the tire circumferential direction, length of the at least one second closed sipe in the tire circumferential direction being greater than length of the at least one second closed sipe in the tire width direction;
wherein the third rib has, at a central portion in the tire width direction of the third rib, at least one third dosed sipe that terminates within the third rib, the at least one third closed sipe being inclined with respect to the tire width direction and the tire circumferential direction, length of the at least one third closed sipe in the tire circumferential direction being greater than length of the at least one third closed sipe in the tire width direction;
wherein the at least one second closed sipe and the at least one third closed sipe are inclined in mutually similar fashion with respect to the tire width direction; and
wherein the at least one first closed sipe is inclined in opposite fashion with respect to the tire width direction as the at least one second closed sipe and the at least one third closed sipe are inclined with respect to the tire width direction.

2. The pneumatic tire according to claim 1 wherein, as seen in plan view,
the length in the tire circumferential direction of the at least one first closed sipe is not less than 1.5 times the length err the tire width direction of the at least one first closed sipe;
the length in the tire circumferential direction of the at least one second closed sipe is not less than 1.5 times the length in the tire width direction of the at least one second closed sipe; and
the length in the tire circumferential direction of the at least one third closed sipe is not less than 1.5 times the length in the tire width direction of the at least one third closed sipe.

3. The pneumatic tire according to claim 1
wherein the second rib has at least one pair of second slits that extend in the tire circumferential direction and that open into the second pair of major grooves, the at least one second closed sipe being arranged in interposed fashion between. the at least one pair of second slits; and
wherein the third rib has at least one pair of third slits that extend in the tire circumferential direction and that open into the third pair of major grooves, the at least one third closed sipe being arranged in interposed fashion between the at least one pair of third slits.

4. The pneumatic tire according to claim 3
wherein length in the tire circumferential direction of each of the second slits is not less than 0.8 but not greater than 1.2 times length in the tire width direction of each of the second slits; and
wherein length in the tire circumferential direction of each of the third slits is not less than 0.8 but not greater than 1.2 times length in the tire width direction of each of the third slits.

5. The pneumatic tire according to claim 3
wherein, as seen when projected onto an equatorial plane, at least one of the second slits and at least one of the third slits at least partially mutually overlap to create at least one overlapping region; and
wherein, as seen when projected onto the equatorial plane, at least a portion of the at least one first closed sipe lies within the at least one overlapping region.

6. The pneumatic tire according to claim 5 wherein, as seen when projected onto the equatorial plane, the at least one first closed sipe lies entirely within the at least one overlapping region.

7. The pneumatic tire according to claim 5 wherein, as seen when projected onto the equatorial plane, length in the tire circumferential direction of the at least one overlapping region is not less than 40% but not greater than 80% of length in the tire circumferential direction of the at least one second slit and of the at least one third slit that appear to mutually overlap as seen when projected onto the equatorial plane.

8. The pneumatic tire according to claim 1
wherein the first pair of major grooves respectively extend in zigzag fashion in the tire circumferential direction such that at least one groove wall of the first pair of major grooves has at least one convex groove wall portion and at least one concave groove wall portion;
wherein each of the first pair of major grooves has a greater groove width at a base thereof than at an opening thereof, and
wherein at least one shelf portion protrudes from the groove base at the at least one concave groove wall portion.
